(19) United States
(12) Patent Application Publication
(10) Pub. No.: US 2025/0363414 A1
(43) Pub. Date: Nov. 27, 2025

(54) TIME-BASED EXPLAINABILITY SCHEME FOR MACHINE LEARNING MODELS

(71) Applicant: Optum, Inc., Minnetonka, MN (US)

(72) Inventors: Davin A. HILL, Everett, MA (US); Brian Lawrence HILL, Culver City, CA (US); Vijay S. NORI, Roswell, GA (US); Robert Elliott TILLMAN, Long Island City, NY (US); Eran HALPERIN, Santa Monica, CA (US)

(21) Appl. No.: 18/882,283

(22) Filed: Sep. 11, 2024

Related U.S. Application Data
(60) Provisional application No. 63/650,163, filed on May 21, 2024.

(51) Int. Cl. G06N 20/00

(52) U.S. Cl. CPC G06N 20/00

(57) ABSTRACT

Various embodiments of the present disclosure provide explainability pipelines for improving the explainability of black box machine learning model. An explainability pipeline may include generating, using a target machine learning model, a model output based on a temporally ordered input feature sequence that comprises a plurality of features respectively assigned to a plurality of time positions within the temporally ordered input feature sequence. The explainability pipeline may include generating a plurality of feature subsets and time permuted feature subsets from the temporally ordered input feature sequence. The explainability pipeline may include generating, using the target machine learning model, an evaluation output for each of the plurality of time permuted feature subsets and identifying a time impact prediction of a target feature from the plurality of features based on the evaluation outputs and the model output.

### CROSS REFERENCE TO RELATED APPLICATIONS

This application claims priority to Provisional Application No. 63/650,163, entitled “ORD-SHAP: FEATURE ORDERING IMPORTANCE FOR SEQUENTIAL BLACK-BOX MODELS”, filed May 21, 2024, the content of which is incorporated herein by reference in its entirety

### BACKGROUND

Various embodiments of the present disclosure address technical challenges related to black box machine learning model and, more specifically, to the lack of explainability of such models. Deep learning models, such as Recurrent Neural Networks, Transformers, and/or the like, are highly effective on sequential data due to architectural designs that capture and learn from the sequential dependencies between data features within a temporally ordered input feature sequence. Despite their effectiveness, these sequential models are opaque, necessitating post-hoc feature attribution methods to understand which features are most relevant to model predictions. Traditional feature attribution methods include techniques, such as feature masking, model gradients, or attention weights, to evaluate how changes to the input sample impact model predictions. However, existing methods typically assume a fixed ordering of features, which conflates attributions associated with a feature's value and those associated with a feature's position within the sample sequence. This leads to misleading explainability measures for black box machine learning models.

Various embodiments of the present disclosure make important contributions to traditional machine learning explainability techniques by addressing these technical challenges, among others.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for a time-based explainability framework in accordance with some embodiments discussed herein.

FIG. 5 is an operational example showing example feature data structures leveraged by a time-based explainability framework in accordance with some embodiments discussed herein.

FIG. 6 is an operational example showing an example time-based feature importance representation in accordance with some embodiments discussed herein.

FIG. 7 is a flowchart diagram of an example process for implementing a time-based explainability framework in accordance with some embodiments discussed herein.

### DETAILED DESCRIPTION

Various embodiments of the present disclosure provide machine learning techniques that improve upon the explainability of machine learning models, including black box machine learning models. Traditional explainability mechanisms, such as Shapley measures, measure the impact that the presence of a feature value has on a model's output. However, they fail to account for the timing of the feature within a particular input. This technical deficiency prevents the detection of timing anomalies in which a machine learning model may inadvertently learn erroneous temporal relationships that ultimately decrease the performance of the model. Some embodiments of the present disclosure address this technical deficiency by implementing an explainability pipeline in which time impact predictions are made for features within an individual machine learning model input. In this manner, the explainability pipeline (e.g., ORD-SHAP) may provide a local feature attribution technique for sequential black box models (e.g., transformer-based models, etc.) that quantifies the effect of feature ordering on model prediction. The explainability pipeline may adapt traditional explainability functions, such as Shapley, to feature attributions on sequential models and then use a weighted least squares approach to efficiently estimate the contribution of each feature's position. In some examples, the explainability pipeline may be extended to identify pairs of features that have an interaction effect due to their sequential ordering. By doing so, the explainability pipeline may provide improved evaluation techniques for machine learning models that directly address technical challenges within machine learning technology. This, in turn, provides improved machine learning model performance and reliability, while reducing training time, processing resources, and evaluation constraints that traditionally hinder the use of machine learning on traditional computer architectures.

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

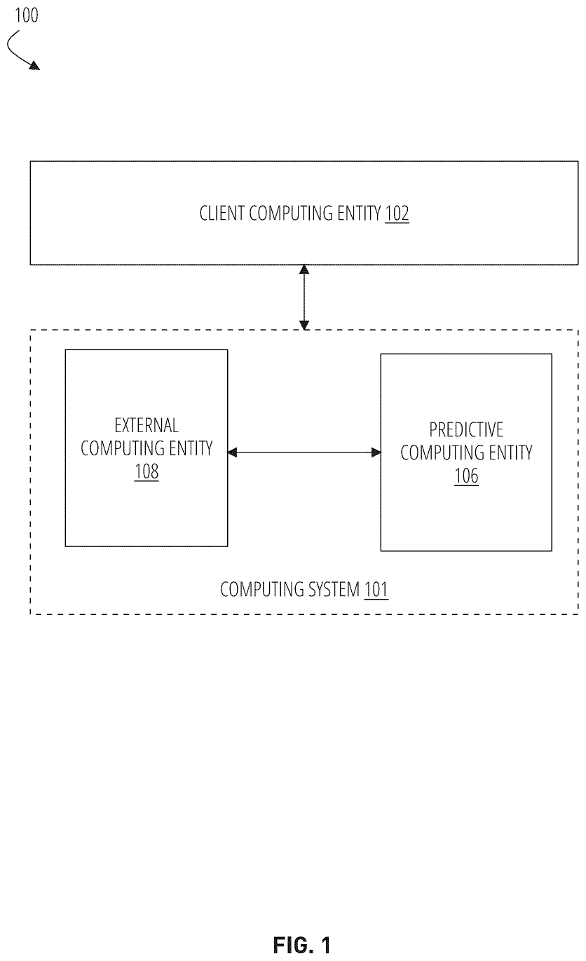

FIG. 1 provides an example overview of an architecture 100 in accordance with some embodiments of the present disclosure. The architecture 100 includes a computing system 101 configured to receive requests, such as a generative text request, from client computing entities 102, process the requests to generate predictive outputs, and provide the predictive outputs to the client computing entities 102. The example architecture 100 may be used in a plurality of domains and not limited to any specific application as disclosed herewith. The plurality of domains may include banking, healthcare, industrial, manufacturing, education, retail, technology, to name a few.

In accordance with various embodiments of the present disclosure, one or more machine learning models may be trained to generate time impact predictions, model outputs, and/or the like. The models may form an explainability pipeline that may be configured to automatically generate and evaluate model outputs and then leverage the model outputs to perform a task. This technique will lead to more accurate and reliable machine learning models that may be efficiently used for diverse set of different use cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as model outputs, time impact predictions, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., explainability techniques, and/or the like) described herein. The external computing entities 108, for example, may include and/or be associated with one or more entities that may be configured to receive, transmit, store, manage, and/or facilitate datasets. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

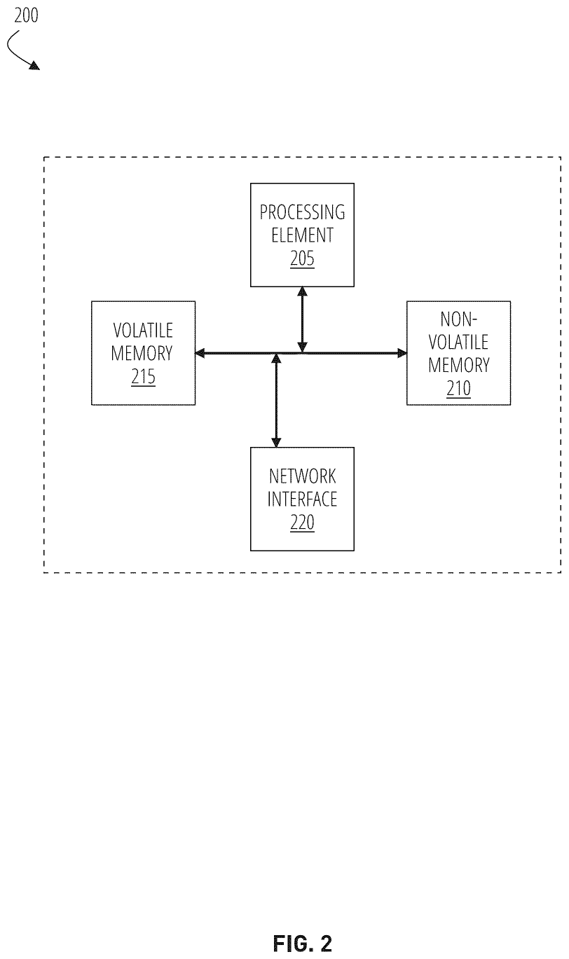

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, which may be one or more predictive computing entities) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Examples of a combination of hardware and computer program products include application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-transitory computer readable media, such as non-volatile media (also referred to as non-volatile storage, memory, memory storage, memory circuitry, and/or similar terms used herein interchangeably) and/or volatile media (also referred to as volatile storage, memory, memory storage, memory circuitry, and/or similar terms used herein interchangeably), as discussed above.

As will be recognized, the non-volatile media and/or the volatile media may store respective part(s) of one or more databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

As indicated, in some embodiments, the computing entity 200 may also include one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. The network interfaces 220, for example, may include one or more wired communication protocols, such as universal serial bus (USB), universal asynchronous receiver/transmitter (UART), IEEE 802.2 (Ethernet), Recommended Standard 232 (RS-232), Recommended Standard 485 (RS-485), and/or the like, and/or one or more wireless communication protocols, such a Wireless Fidelity (Wi-Fi), Bluetooth®, Zigbee®, Z-Wave, and/or the like.

Although not shown, the computing entity 200 may additionally or alternatively include, or be in communication with, one or more input elements/devices, such as input sensor(s). In some examples, the input sensor(s) may include one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively include, or be in communication with, one or more output elements/devices (not shown), such as one or more speakers, visual display devices, haptic feedback devices, motion devices (e.g., electromechanically actuated devices), and/or the like.

### B. Example Client Computing Entity

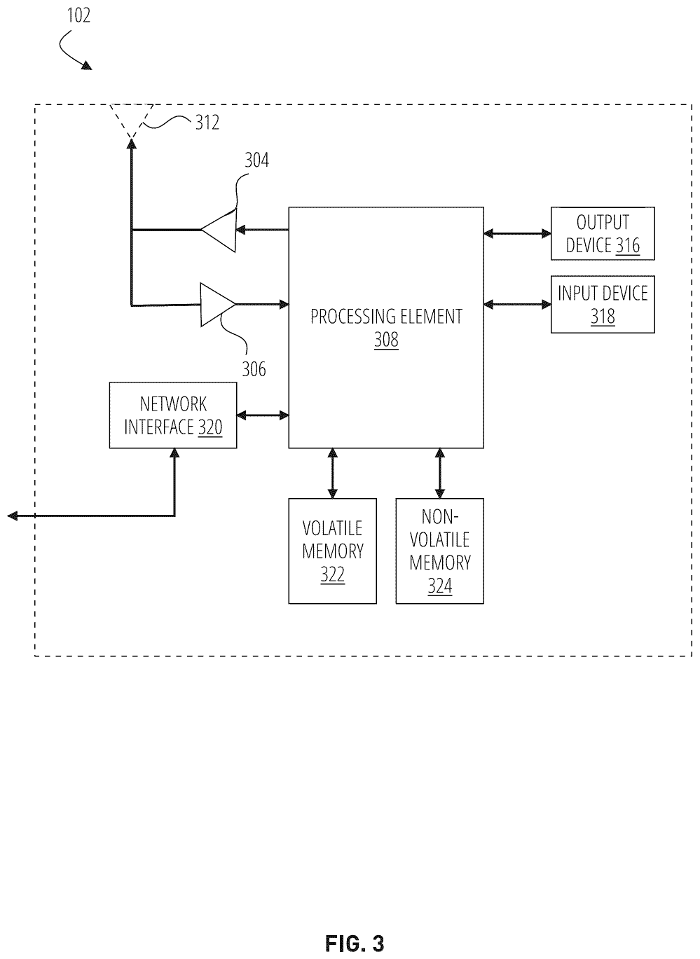

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably.

For example, the client computing entity 102 may include outdoor positioning aspects, such as a location component adapted to acquire, for example, latitude, longitude, altitude, geocode, course, direction, heading, speed, coordinated universal time (UTC), date, and/or various other information/data. In some embodiments, the location component may acquire data, sometimes known as ephemeris data, by identifying the number of satellites in view and the relative positions of those satellites (e.g., using global positioning systems (GPS)). Additionally, or alternatively, location component may acquire triangulation data in connection with a variety of other systems, including cellular towers, WiFi access points, and/or the like. In some examples, outdoor positioning aspects of the present disclosure may be used in a variety of settings to determine the location of someone or something within a geographic environment.

Similarly, the client computing entity 102 may include indoor positioning aspects, such as a location component adapted to acquire, for example, latitude, longitude, altitude, geocode, course, direction, heading, speed, time, date, and/or various other information/data. Some of the indoor systems may use various position or location technologies including radio frequency identification (RFID) tags, active and/or passive radio beacons (e.g., Wi-Fi beacons), and/or the like. In some examples, indoor positioning aspects of the present disclosure may be used in a variety of settings to determine the location of someone or something to within inches or centimeters.

The client computing entity 102 may also comprise a user interface (that may include an output device 316 (e.g., similar to or different than the output device(s) discussed above) coupled to a processing element 308 and/or a user input device (e.g., an input sensor(s), similar to or different than the input sensor(s) discussed above) coupled to the processing element 308. In some examples, the user interface may additionally or alternatively comprise software component(s) executed by the processing element 308 to present (e.g., audibly, visually, tactilely) via an input and/or output device and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may also include volatile memory 322 and/or non-volatile memory 324, which may be embedded and/or may be removable.

For example, the non-volatile memory 324 may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as a smart assistant, AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “temporally ordered input feature sequence” refers to a data structure that describes an input to a machine learning model. A temporally ordered input feature sequence, for example, may include one or more features that are arranged based on a plurality of timing attributes of the features. For example, a temporally ordered input feature sequence may include a single ordered sequence of features. A temporally ordered input feature sequence may include features from any temporally related data, such as one or more historical data objects as described herein. An initial ordering of the temporally ordered input feature sequence may be defined by the data (e.g., historical time points from a historical data object, etc.). In some examples, the initial ordering may be denoted as σ_{N}.

A temporally ordered input feature sequence may define a temporal ordering of a plurality of features associated with a data entity. For instance, a temporally ordered input feature sequence may include a plurality of features that are respectively arranged according to a plurality of time positions defined by the temporally ordered input feature sequence. Each feature may be positioned at a time position based on an occurrence of the feature in the temporally related data. For example, a first feature that occurs at a first time within the temporally related data may be placed a time position before a second feature that occurs at a second time, subsequent to the first time, within the temporally related data. In this manner, a temporally ordered input feature sequence may define a sequence of features in the order in which the features are observed within temporally related data.

In some embodiments, the term “data entity” refers to an entity that is associated with a plurality of features. A data entity, for example, may include a grouping identifier for a plurality of features. A data entity may depend on a prediction domain. Generally, it can be any type of grouping identifier for which a prediction may be generated within a particular prediction domain. By way of example, in a clinical domain, a data entity may correspond to a patient associated with a plurality of clinically related features, such as current procedural codes (CPT) or international classification of disease (ICD) codes. Other examples may include a hardware component in a computing domain in which the hardware component is associated with a plurality of performance features, such as usage rates, temperature conditions, humidity conditions, and/or the like.

In some examples, a temporally ordered input feature sequence may correspond to a single data entity. For example, a temporally ordered input feature sequence may include a plurality of features extracted from a plurality of historical, current, and/or future records associated with the single data entity. By way of example, the plurality of features may be extracted from a plurality of historical data objects associated with a data entity.

In some embodiments, the term “historical data object” refers to a data structure that defines one or more features for a data entity. A historical data object, for example, may include a record that describes an event associated with a data entity. A historical data object may depend on a prediction domain. For instance, in a clinical domain, a historical data object may include a medical record representing one or more diagnosis and/or procedural codes at a particular time. As another example, in a computing diagnostics domain, a historical data object may include a diagnosis report for a hardware component. Each diagnosis report, for example, may include a plurality of processing attributes at a particular time that may be processed over time to detect anomalous behavior (e.g., a virus, etc.).

In some embodiments, the term “historical time point” refers to a timing attribute of a historical data object. A historical time point, for example, may include a creation timestamp from a historical data object. For example, a historical time point may include a timestamp defining a time at which a historical data object is created. In addition, or alternatively, a historical time point may include an event timestamp defining a time at which an event recorded by the historical data object occurs. In some examples, a historical time point may include a feature time stamp defining a time at which a feature is expressed or recorded during one or more events recorded by the historical data object.

In some embodiments, the term “feature” refers to a predictive attribute of a historical data object. A feature may include a time-based feature that includes a timing attribute (e.g., a relative or absolute position) and a predictive attribute (e.g., a medical code, diagnosis code, diagnostic code, etc.). By way of example, in a clinical domain, a feature may include a medical code represented at a particular time within a patient record, in a computer diagnostics domain, a feature may include a diagnostic code represented at a particular time within a diagnostic record, and/or the like.

In some embodiments, the term “time position” refers to a timing attribute of a feature within a feature sequence. A time position may be an absolute position and/or a relative position of a feature within a feature sequence.

In some examples, a feature may be assigned to multiple positions throughout the explainability pipeline of the present disclosure to derive an impact of the timing of the feature to a predictive output of a machine learning model. For example, a time position of a feature may include an initial position that describes a position of the feature within a temporally ordered input feature sequence. In addition, or alternatively, a time position of a feature may include a subset position that describes a position of the feature within a feature subset of a temporally ordered input feature sequence. As another example, a time position of a feature may include a permuted position that describes a position of the feature within a time permuted feature subset sampled from the temporally ordered input feature sequence. As yet another example, a time position of a feature may include an inverse permuted position that describes a difference between an initial position (and/or subset position) and permuted position of the feature.

In some embodiments, the term “target machine learning model” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). The target machine learning model may include any type of model configured, trained, and/or the like to process a temporally ordered input feature sequence and, in response to the temporally ordered input feature sequence, provide a model output. A target machine learning model may include one or more of any type of machine learning model including one or more supervised, unsupervised, semi-supervised, and/or reinforcement learning models. In some embodiments, the target machine learning model may include multiple models configured to perform one or more different stages of a prediction process.

In some examples, a target machine learning model, denoted as v, may include a black box model, such as a previously trained transformer (e.g., bi-directional encoder representations from transformers (BERT) model, etc.), recurrent neural network (e.g., long short-term memory (LSTM) model, etc.), and/or the like that receives a temporally ordered input feature sequence and return a model output.

In some embodiments, the term “model output” refers to an unexplainable output received from a target machine learning model in response to a temporally ordered input feature sequence. For example, a model output may include a numeric value (e.g., probability for binary classification, scaler value for regression, etc.) and/or a set of numeric values in the case of multi-class/multi-label classification or multi-output regression. A model output, denoted as ν(σ_{N}), may be generated based on an initial ordering, denoted as σ_{N}, of the temporally ordered input feature sequence. In some examples, the model output may include multi-class/multi-label classification or multi-output regression output.

In some embodiments, the term “feature subset” refers to a set of features sampled from a temporally ordered input feature sequence. A feature subset, for example, may include a vector of features that include a segment from the temporally ordered input feature sequence that maintains the timing attributes of the temporally ordered input feature sequence. For instance, the set of features of a feature subset may include one or more of the plurality of features from the temporally ordered input feature sequence that are arranged in the same order defined by the temporally ordered input feature sequence.

In some examples, a plurality of feature subsets may be sampled from a temporally ordered input feature sequence to sample a plurality of variations of features from the temporally ordered input feature sequence without impacting the timing of the features within the temporally ordered input feature sequence. For example, K sample feature subsets may be drawn from the temporally ordered input feature sequence. The values for K (e.g., number of feature subsets), may be defined by a hyperparameter where large values of K may improve the estimates of the explainability values described herein at the cost of increased compute time. In some examples, K may be defined based on a threshold compute time and/or cost to optimize the predictive accuracy of the explainability values with respect to available compute.

In some examples, each of a plurality of feature subsets may include a static feature size that defines a predefined number (e.g., five, ten, fifty, etc.) of features sampled from a temporally ordered input feature sequence. In addition, or alternatively, the plurality of feature subsets may include dynamic feature sizes or varying sizes. For instance, a dynamic feature size may be leveraged to increase a number of the plurality of feature subsets. In the event that dynamic feature sizes are leveraged, each feature subset may include an evenly sized vector by adding blank values to feature subsets with less than a maximum number of features.

In some embodiments, the term “time permuted feature subset” refers to a set of rearranged features sampled from a temporally ordered input feature sequence. A time permuted feature subset, for example, may include a feature subset that is rearranged to randomly reorder the set of features of the feature subset. In this manner, a time permuted feature subset may include a segment from the temporally ordered input feature sequence that disrupts the timing attributes of the temporally ordered input feature sequence. For instance, the set of features of a time permuted feature subset may include one or more of the plurality of features from the temporally ordered input feature sequence that are arranged in a different order defined by the temporally ordered input feature sequence.

In some examples, a plurality of time permuted feature subsets may be sampled from each feature subset of a temporally ordered input feature sequence to sample a plurality of timing variations of the features within the temporally ordered input feature sequence. For example, for each of the K sample subsets, L permutations may be sampled to generate KL time permuted feature subsets. The values for L (e.g., number of time permuted feature subsets per feature subset), may be defined by a hyperparameter where large values of L may improve the estimates of the explainability values described herein at the cost of increased compute time. In some examples, L may be defined based on a threshold compute time and/or cost to optimize the predictive accuracy of the explainability values with respect to available compute.

In some embodiments, the term “permutation matrix” refers to a data structure that describes each of a plurality of time permuted feature subsets. A permutation matrix, for example, may include a data representation of a plurality of time permuted feature subsets, KL.

In some embodiments, the term “inverse permuted feature subset” refers to a set of values that describe a difference between a permuted position of a feature and the feature's original position in a temporally ordered input feature sequence. For example, an inverse permuted feature subset may be generated for each time permuted feature subset to describe an absolute distance between each feature's (i) original position in the temporally ordered input feature sequence and (ii) permuted position in the time permuted feature subset. In addition, or alternatively, an inverse permuted feature subset may be generated for each time permuted feature subset to describe a relative distance between each feature's (i) original position in a feature subset and (ii) permuted position in the time permuted feature subset.

In some embodiments, an inverse permuted feature subset is generated by applying a permutation inverse transformation model to a time permuted feature subset. For instance, a time permuted feature subset may be input to the permutation inverse transformation model to return an inverse permuted feature subset for the time permuted feature subset. The permutation inverse transformation model, for example, may return the index of each feature, j, from a feature subset in a corresponding time permuted feature subset. For example, if a feature subset: (1, 2, 3, 4), is permuted to generate the time permuted feature subset: σ=(σ(1), σ(2), σ(3), σ(4))=(3, 2, 4, 1), then the inverse permuted feature subset may be: −1=(σ⁻¹(1), σ⁻¹(2), σ⁻¹(3), σ⁻¹(4))=(4, 2, 1, 3). In this manner, the inverse permuted feature subset may identify the permuted position in a time permuted feature subset where a feature, j, was moved to (e.g., in the time permuted feature subset, feature 1 went to position 4, feature 2 stayed in position 2, feature 3 went to position 1, etc.) in order to quantify how far each feature is moved within a time permuted feature subset.

In some embodiments, the term “transformed permutation matrix” refers to a data structure that describes each of a plurality of inverse permuted feature subsets. A permutation matrix, for example, may include a data representation of a plurality of inverse permuted feature subsets. For instance, the plurality of inverse permuted feature subsets may be arranged into the matrix Σ∈ [symbol] where each element Σ_{i,j} is a sampled permutation inverse \hat{σ}ᵢ⁻¹(j). If using the absolute position in the temporally ordered input feature sequence, Σ may be used without any further transformations. If using relative position in the temporally ordered input feature sequence, the original position index σ_{N} (i.e., (1, 2, 3, . . . , d)) may be subtracted from each row in Σ. In such a case, the inverse permuted feature subset for the above example may be: (−2, 0, −1, +3).

In some embodiments, the term “weighted transformed permutation matrix” refers to a data structure that describes a weighted probability of each of a plurality of time permuted feature subsets. A weighted transformed permutation matrix, for example, may include a transformation of the transformed permutation matrix that weights each of the plurality of inverse permuted feature subsets based on a weighting matrix. For example, to weigh each sample, a diagonal weighting matrix W∈[0,1]^{KL×KL} may be created where each diagonal element is the corresponding weight of each sample μ(sₖ)α(σₖₗ), where μ(sₖ) is the weight of sample subset sₖ and α(σₖₗ) is the weight of permutation σₖₗ.

In some examples, each weight may be uniform (e.g., equal weights to all sample subsets and/or permutations). By way of example, the coefficient α(σ) may be uniform in the general formulation. In addition, or alternatively, each weigh may be used to prioritize feature subsets and/or time permuted feature subsets based on one or more weighting criteria. The weighting criteria, for example, may include a likelihood probability in which a weight is generated based on a likelihood of a feature subset and/or time permuted feature subset in a real-world scenario. In this manner, the coefficient α(σ) may be used to enforce a priori constraints that restrict the set of permutations (e.g., only sample realistic permutations). By way of example, α(σ) may be proportional to the likelihood of a given time permuted feature subset.

In some embodiments, the term “classification machine learning model” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). The classification machine learning model may include any type of model configured, trained, and/or the like to process a time permuted feature subset and, in response to the time permuted feature subset, output a likelihood prediction for the time permuted feature subset. In some examples, the classification machine learning model may include a neural network architecture that is trained, using backpropagation of errors, to optimize a likelihood loss (e.g., using a maximum likelihood estimation, etc.). The classification machine learning model, for example, may be trained using a distribution of a plurality of historical temporally ordered input feature sequences.

In some embodiments, the term “evaluation output” refers to an unexplainable output received from a target machine learning model in response to a time permuted feature subset. An evaluation output, for example, may be generated by inputting a time permuted feature subset to the target machine learning model. In some examples, an evaluation output may be generated for each of a plurality of time permuted feature subsets. For example, for each of the KL time permuted feature subsets, a time permuted feature subset may be input to the target machine learning model to generate an evaluation output (e.g., predicted probability for a classification, etc.). In some examples, the evaluation outputs may be stored to generate an evaluation output vector F∈ [symbol] . The evaluation output vector, for example, may include an evaluation output for each time permuted feature subset of a permutation matrix.

In some embodiments, the term “time impact prediction” refers to a data value that describes a relative measure of the impact of a time variance for a time-based feature to an output by a machine learning model. A time impact prediction, for example, may include an explainability value specifically designed to explain a temporal significance of a feature within a temporally ordered input feature sequence. In some examples, a time impact prediction may include an aggregation of a plurality of augmented Shapley values, Ord-SHAP, that may be generated, using weighted least-squares regression. In addition, or alternatively, Shapley sampling values, and/or the like, may be leveraged to generate a time impact prediction.

In some embodiments, a time impact prediction is based on a Shapley coefficient φ, solved using the following equation:

$$φ = {( {Σ}^{T} W Σ )}^{- 1} {Σ}^{T} W F$$

The Shapley coefficient, φ, may measure an effect (e.g., weight) of varying the position of each feature in the temporally ordered input feature sequence on a model output, given the specific ordering of the temporally ordered input feature sequence. In this manner, a time impact prediction may provide a local attribution measure (e.g., specific to a particular temporally ordered input feature sequence) as opposed to traditional explainability techniques that are limited to global attribution measures (e.g., the effect across a plurality of temporally ordered input feature sequences in a distribution).

In some examples, a magnitude of a plurality of Shapley coefficients (e.g., regression weights) may be compared to determine the time impact prediction for a target feature. For instance, a time impact prediction may be output for each time-based feature that reflects the feature's temporal significance. The time impact prediction may be an aggregation of the Shapley coefficients (e.g., resulting coefficients are the Ord-SHAP values) for a particular time-based feature (e.g., target feature).

In some embodiments, the term “target feature” refers to a feature of a temporally ordered input feature sequence that is associated with explainable metadata. A target feature, for example, may include a time-based feature that is associated with a time impact prediction.

In some embodiments, the term “quantile bin” refers to a data structure that describes a feature associated with a range of time impact values. A quantile bin, for example, may be based on a distribution of time impact values and/or Shapley coefficients for a temporally ordered input feature sequence. For example, a quantile bin may include an evenly divided portion of the Shapley coefficients (and/or time impact values) that is determined by dividing the Shapley coefficients into bins based on a bin size (e.g., quartiles (four bins), quintiles (five bins), deciles (ten bins), etc.). In some examples, a plurality of time impact values (e.g., one for each time-based feature of a temporally ordered input feature sequence, etc.) may be binned by quantiles, based on a distribution of the Shapley coeffects, and/or the like, to determine a relative significance between each of the time-based features of the temporally ordered input feature sequence.

In some embodiments, the term “time-based feature importance representation” refers to a graphical representation that describes a relative importance of a timing expressed by a temporally ordered input feature sequence. A time-based feature importance representation may include a model explainability user interface configured to describe a relative importance of the specific ordering in a temporally ordered input feature sequence to a model output. In some examples, the time-based feature importance representation may include a plurality of time-based features extracted from a temporally ordered input feature sequence and plotted along an importance axis to visually illustrate the relative importance of each of the time-based features of the temporally ordered input feature sequence.

In some examples, a time-based feature importance representation may include a plurality of different explainability measures for each of a plurality of time-based features. The plurality of different explainability measures, for example, may include traditional feature importance measures, such as Kernel SHAP values, and/or the like, that measure an importance of a presence and/or absence of a feature in a feature sequence. By way of example, a time-based feature importance representation may include a multi-dimensional representation in which each feature of a temporally ordered input feature sequence is positioned based on a plurality of explainability measures. For instance, a feature may be positioned along a first dimension based on a presence measure (Kernel SHAP, etc.) of an importance of the presence of the feature to a model output. In addition, or alternatively, a feature may be positioned along a second dimension based on a timing measure (e.g., time impact prediction, etc.) of an importance of the timing of the feature to a model output.

### IV. OVERVIEW

Various embodiments of the present disclosure provide machine learning techniques that improve upon the explainability of machine learning models, including black box machine learning models. To do so, the present disclosure provides an explainability pipeline that outputs time impact predictions for features within a temporal input to a machine learning model. In this manner, the explainability pipeline (e.g., ORD-SHAP) may provide a local feature attribution technique for sequential black box models (e.g., transformer-based models, etc.) that quantifies the effect of feature ordering on model prediction. By doing so, the explainability pipeline may provide improved evaluation techniques for machine learning models that directly address technical challenges within machine learning technology. This, in turn, provides improved machine learning model performance and reliability, while reducing training time, processing resources, and evaluation constraints that traditionally hinder the use of machine learning on traditional computer architectures.

Traditional feature attribution methods, such as feature masking, model gradients, or attention weights, may identify the most relevant features that contribute to a machine learning model's output by evaluating how changes to an input sample impact model predictions. To do so, such techniques assume a fixed ordering of features, which conflates attributions associated with the feature's value and those associated with the feature's position within the input sample. This skews the attribution of the feature's value, while preventing an evaluation of the temporal significance of a feature within an input sample. To address this technical deficiency, the evaluation pipeline of the present disclosure improves upon traditional feature attribution approaches by permuting and then evaluating different arrangements of features from an input sample. In this way, the explainability pipeline may isolate time impact predictions for a model input from the impact of a feature's value. By doing so, the explainability pipeline may explain the contribution of both a feature's value and a feature's timing within a model input to an output generated by the model. This enables an understanding of how the ordering of input features influences model predictions, which is overlooked by traditional feature attribution techniques.

Examples of technologically advantageous embodiments of the present disclosure include: (i) machine learning pipelines, (ii) explainability techniques, and (iii) user interfaces for efficiently providing explainability measures, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to black box machine learning techniques that, due to their black box architectural constraints, inherently lack reliability and transparency into their outputs. In particular, systems and methods are disclosed herein that implement an explainability pipeline that improves the explainability of model outputs with respect traditional feature attribution techniques. Unlike traditional feature attribution techniques, the explainability pipeline may isolate the influence of the timing of feature from the feature's value within an input sequence. By doing so, some of the techniques of the present disclosure may allow for a more accurate and contextualized understanding of the inner workings of various machine learning models, which may enable compliance mechanisms to improve the reliability, transparency, and performance of such models.

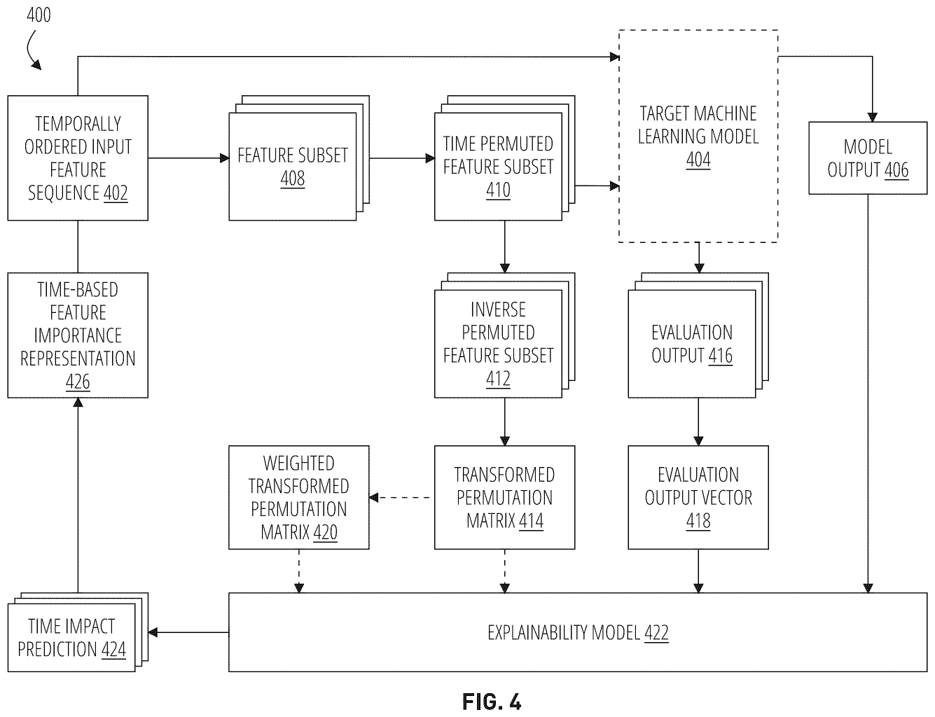

FIG. 4 is a dataflow diagram 400 showing example data structures and modules for a time-based explainability framework in accordance with some embodiments discussed herein. The dataflow diagram 400 illustrates a local feature attribution technique for generating a time-based feature importance representation 426 that corresponds to a temporally ordered input feature sequence 402 using a time-based explainability framework. As described herein, the time-based feature importance representation 426 may reflect a plurality of time impact predictions for the temporally ordered input feature sequence 402 that describe the impact that varying a feature's position within the temporally ordered input feature sequence 402 has on a model output 406 provided by a target machine learning model 404. In this way, by using the techniques of the present disclosure, a time-based feature importance representation 426 may be output for each individual model input that reflects the impact of both the presence of a feature and the position of the feature within the model input to an output of the target machine learning model 404. By doing so, the time-based explainability framework of the present disclosure may improve the interpretability of model outputs with respect to a temporally ordered input feature sequences. This may ultimately allow for increased model reliability, as well as, compliance techniques that may detect and adjust a model outputs based on previously undetectable anomalies.

In some embodiments, a temporally ordered input feature sequence 402 is received for input to a target machine learning model 404. The temporally ordered input feature sequence 402 may include a plurality of features respectively assigned to a plurality of time positions within the temporally ordered input feature sequence 402. In some examples, the temporally ordered input feature sequence 402 may correspond to a data entity that is associated with a plurality of historical data objects respectively corresponding to one or more historical time points. The temporally ordered input feature sequence 402 may be generated by identifying one or more features from each of the plurality of historical data objects and concatenating the one or more features from each of the plurality of historical data objects in accordance with the plurality of time positions based on the one or more historical time points.

In some embodiments, the temporally ordered input feature sequence 402 is a data structure that describes an input to a machine learning model. A temporally ordered input feature sequence 402, for example, may include one or more features that are arranged based on a plurality of timing attributes of the features. For example, the temporally ordered input feature sequence 402 may include a single ordered sequence of features. A temporally ordered input feature sequence 402 may include features from any temporally related data, such as one or more historical data objects as described herein. An initial ordering of the temporally ordered input feature sequence 402 may be defined by the data (e.g., historical time points from a historical data object, etc.). In some examples, the initial ordering may be denoted as UN.

A temporally ordered input feature sequence 402 may define a temporal ordering of a plurality of features associated with a data entity. For instance, a temporally ordered input feature sequence 402 may include a plurality of features that are respectively arranged according to a plurality of time positions defined by the temporally ordered input feature sequence 402. Each feature may be positioned at a time position based on an occurrence of the feature in the temporally related data. For example, a first feature that occurs at a first time within the temporally related data may be placed a time position before a second feature that occurs at a second time, subsequent to the first time, within the temporally related data. In this manner, a temporally ordered input feature sequence 402 may define a sequence of features in the order in which the features are observed within temporally related data.

In some embodiments, a data entity is an entity that is associated with a plurality of features. A data entity, for example, may include a grouping identifier for a plurality of features. A data entity may depend on a prediction domain. Generally, it can be any type of grouping identifier for which a prediction may be generated within a particular prediction domain. By way of example, in a clinical domain, a data entity may correspond to a patient associated with a plurality of clinically related features, such as CPT or ICD codes. Other examples may include a hardware component in a computing domain in which the hardware component is associated with a plurality of performance features, such as usage rates, temperature conditions, humidity conditions, and/or the like.

In some examples, a temporally ordered input feature sequence 402 may correspond to a single data entity. For example, a temporally ordered input feature sequence 402 may include a plurality of features extracted from a plurality of historical, current, and/or future records associated with the single data entity. By way of example, the plurality of features may be extracted from a plurality of historical data objects associated with a data entity.

In some embodiments, a historical data object is a data structure that defines one or more features for a data entity. A historical data object, for example, may include a record that describes an event associated with a data entity. A historical data object may depend on a prediction domain. For instance, in a clinical domain, a historical data object may include a medical record representing one or more diagnosis and/or procedural codes at a particular time. As another example, in a computing diagnostics domain, a historical data object may include a diagnosis report for a hardware component. Each diagnosis report, for example, may include a plurality of processing attributes at a particular time that may be processed over time to detect anomalous behavior (e.g., a virus, etc.).

In some embodiments, the historical time point is a timing attribute of a historical data object. A historical time point, for example, may include a creation timestamp from a historical data object. For example, a historical time point may include a timestamp defining a time at which a historical data object is created. In addition, or alternatively, a historical time point may include an event timestamp defining a time at which an event recorded by the historical data object occurs. In some examples, a historical time point may include a feature timestamp defining a time at which a feature is expressed or recorded during one or more events recorded by the historical data object.

In some embodiments, the feature is a predictive attribute of a historical data object. A feature may include a time-based feature that includes a timing attribute (e.g., a relative or absolute position) and a predictive attribute (e.g., a medical code, diagnosis code, diagnostic code, etc.). By way of example, in a clinical domain, a feature may include a medical code represented at a particular time within a patient record, in a computer diagnostics domain, a feature may include a diagnostic code represented at a particular time within a diagnostic record, and/or the like.

In some embodiments, the time position a timing attribute of a feature within a feature sequence. A time position may be an absolute position and/or a relative position of a feature within a feature sequence.

In some examples, a feature may be assigned to multiple positions throughout the explainability pipeline of the present disclosure to derive an impact of the timing of the feature to a predictive output of a machine learning model, such as the target machine learning model 404. For example, a time position of a feature may include an initial position that describes a position of the feature within the temporally ordered input feature sequence 402. In addition, or alternatively, a time position of a feature may include a subset position that describes a position of the feature within a feature subset 408 of the temporally ordered input feature sequence 402. As another example, a time position of a feature may include a permuted position that describes a position of the feature within a time permuted feature subset 410 sampled from the temporally ordered input feature sequence 402. As yet another example, a time position of feature may include an inverse permuted position that describes a difference between an initial position (and/or subset position) and permuted position of the feature.

In some embodiments, a model output 406 is generated based on the temporally ordered input feature sequence 402. For instance, the model output 406 may be generated using the target machine learning model 404. For example, the temporally ordered input feature sequence 402 may be input to the target machine learning model 404 to receive the model output 406.

In some embodiments, the target machine learning model 404 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The target machine learning model 404 may include any type of model configured, trained, and/or the like to process a temporally ordered input feature sequence 402 and, in response to the temporally ordered input feature sequence 402, provide a model output 406. A target machine learning model 404 may include one or more of any type of machine learning model including one or more supervised, unsupervised, semi-supervised, and/or reinforcement learning models. In some embodiments, the target machine learning model 404 may include multiple models configured to perform one or more different stages of a prediction process.

In some examples, the target machine learning model 404, denoted as v, may include a black box model, such as a previously trained transformer (e.g., bi-directional encoder representations from transformers (BERT) model, etc.), recurrent neural network (e.g., long short-term memory (LSTM) model, etc.), and/or the like that receives a temporally ordered input feature sequence 402 and return a model output 406.

In some embodiments, the model output 406 is an unexplainable output received from the target machine learning model 404 in response to the temporally ordered input feature sequence 402. For example, the model output 406 may include a numeric value (e.g., probability for binary classification, scaler value for regression, etc.) and/or a set of numeric values in the case of multi-class/multi-label classification or multi-output regression. A model output, denoted as ν(σ_{N}), may be generated based on an initial ordering, denoted as σ_{N}, of the temporally ordered input feature sequence 402. In some examples, the model output 406 may include multi-class/multi-label classification or multi-output regression output.

In some embodiments, a feature subset 408 is generated from the temporally ordered input feature sequence 402. The feature subset 408 may include a subset of features from the plurality of features that are arranged according to a subset of the plurality of time positions that respectively correspond to the subset of features.

In some embodiments, the feature subset 408 is a set of features sampled from a temporally ordered input feature sequence 402. The feature subset 408, for example, may include a vector of features that include a segment from the temporally ordered input feature sequence 402 that maintains the timing attributes of the temporally ordered input feature sequence 402. For instance, the set of features of the feature subset 408 may include one or more of the plurality of features from the temporally ordered input feature sequence 402 that are arranged in the same order defined by the temporally ordered input feature sequence 402.

In some examples, a plurality of feature subsets 408 may be sampled from the temporally ordered input feature sequence 402 to sample a plurality of variations of features from the temporally ordered input feature sequence 402 without impacting the timing of the features within the temporally ordered input feature sequence 402. For example, K sample feature subsets may be drawn from the temporally ordered input feature sequence 402. The values for K (e.g., number of feature subsets), may be defined by a hyperparameter where large values of K may improve the estimates of the explainability values described herein at the cost of increased compute time. In some examples, K may be defined based on a threshold compute time and/or cost to optimize the predictive accuracy of the explainability values with respect to available compute.

In some examples, each of a plurality of feature subsets 408 may include a static feature size that defines a predefined number (e.g., five, ten, fifty, etc.) of features sampled from the temporally ordered input feature sequence 402. In addition, or alternatively, the plurality of feature subsets 408 may include dynamic feature sizes or varying sizes. For instance, a dynamic feature size may be leveraged to increase a number of the plurality of feature subsets 408. In the event that dynamic feature sizes are leveraged, each feature subset 408 may include an evenly sized vector by adding blank values to feature subsets 408 with less than a maximum number of features.

In some embodiments, a time permuted feature subset 410 is generated from the feature subset 408 by assigning one or more of the subset of features to one or more different time positions of the subset of the plurality of time positions.

In some embodiments, the time permuted feature subset 410 to a set of rearranged features sampled from a temporally ordered input feature sequence 402. The time permuted feature subset 410, for example, may include a feature subset 408 that is rearranged to randomly reorder the set of features of the feature subset 408. In this manner, the time permuted feature subset 410 may include a segment from the temporally ordered input feature sequence 402 that disrupts the timing attributes of the temporally ordered input feature sequence 402. For instance, the set of features of the time permuted feature subset 410 may include one or more of the plurality of features from the temporally ordered input feature sequence 402 that are arranged in a different order defined by the temporally ordered input feature sequence 402.

In some examples, a plurality of time permuted feature subsets 410 may be sampled from each feature subset of a temporally ordered input feature sequence 402 to sample a plurality of timing variations of the features within the temporally ordered input feature sequence 402. For example, for each of the K sample subsets, L permutations may be sampled to generate KL time permuted feature subsets 410 The values for L (e.g., number of time permuted feature subsets 410 per feature subset 408), may be defined by a hyperparameter where large values of L may improve the estimates of the explainability values described herein at the cost of increased compute time. In some examples, L may be defined based on a threshold compute time and/or cost to optimize the predictive accuracy of the explainability values with respect to available compute.

In some embodiments, a permutation matrix is generated by arranging the time permuted feature subset 410 with a plurality of different time permuted feature subsets sampled from the temporally ordered input feature sequence 402. In some embodiments, the permutation matrix to a data structure that describes each of a plurality of time permuted feature subsets 410. A permutation matrix, for example, may include a data representation of a plurality of time permuted feature subsets, KL.

In some embodiments, a transformed permutation matrix 414 is generated by generating an inverse permuted feature subset 412 for the time permuted feature subset 410 and each of the plurality of different time permuted feature subsets. An inverse permuted feature subset 412, for example, may identify a distance between (i) an initial time position of a feature within a feature subset 408 and (ii) a permuted time position of the feature within the time permuted feature subset 410.

In some embodiments, the inverse permuted feature subset 412 is a set of values that describe a difference between a permuted position of a feature and the feature's original position in a temporally ordered input feature sequence 402. For example, an inverse permuted feature subset 412 may be generated for each time permuted feature subset 410 to describe an absolute distance between each feature's (i) original position in the temporally ordered input feature sequence 402 and (ii) permuted position in the time permuted feature subset 410. In addition, or alternatively, the inverse permuted feature subset 412 may be generated for each time permuted feature subset 410 to describe a relative distance between each feature's (i) original position in a feature subset 408 and (ii) permuted position in the time permuted feature subset 410.

In some embodiments, the inverse permuted feature subset 412 is generated by applying a permutation inverse transformation model to a time permuted feature subset 410. For instance, a time permuted feature subset 410 may be input to the permutation inverse transformation model to return an inverse permuted feature subset 412 for the time permuted feature subset 410. The permutation inverse transformation model, for example, may return the index of each feature, j, from a feature subset 408 in a corresponding time permuted feature subset 410. For example, if a feature subset: (1, 2, 3, 4), is permuted to generate the time permuted feature subset: σ=(σ(1), σ(2), σ(3), σ(4))=(3, 2, 4, 1), then the inverse permuted feature subset may be: σ⁻¹ (σ⁻¹(1), σ⁻¹(2), σ⁻¹(3), σ⁻¹(4))=(4, 2, 1, 3). In this manner, the inverse permuted feature subset 412 may identify the permuted position in a time permuted feature subset 410 where a feature, j, was moved to (e.g., in the time permuted feature subset 410, feature 1 went to position 4, feature 2 stayed in position 2, feature 3 went to position 1, etc.) in order to quantify how far each feature is moved within a time permuted feature subset 410.

In some embodiments, the transformed permutation matrix 414 is a data structure that describes each of a plurality of inverse permuted feature subsets 412. A transformed permutation matrix 414, for example, may include a data representation of a plurality of inverse permuted feature subsets 412. For instance, the plurality of inverse permuted feature subsets 412 matrix Σ∈ [symbol] where each element Σ_{i,j} is a sampled permutation inverse \hat{σ}ᵢ⁻¹(j). If using the absolute position in the temporally ordered input feature sequence, Σ may be used without any further transformations. If using relative position in the temporally ordered input feature sequence, the original position index σ_{N} (i.e., (1, 2, 3, . . . , d)) may be subtracted from each row in Σ. In such a case, the inverse permuted feature subset for the above example may be: (−2, 0, −1, +3).

In some embodiments, a weighted transformed permutation matrix 420 is generated from the transformed permutation matrix 414 by applying a diagonal weighting matrix to the transformed permutation matrix 414. In some examples, the diagonal weighting matrix defines a weight for each time permuted feature subset 410 based on a predicted likelihood of the time permuted feature subset 410. In some examples, the predicted likelihood of the time permuted feature subset 410 is generated using a classification machine learning model previously trained on a plurality of labelled feature subsets.

In some embodiments, the weighted transformed permutation matrix 420 is a data structure that describes a weighted probability of each of a plurality of time permuted feature subsets 410. A weighted transformed permutation matrix 420, for example, may include a transformation of the transformed permutation matrix 414 that weights each of the plurality of inverse permuted feature subsets 412 based on a weighting matrix. For example, to weigh each sample, a diagonal weighting matrix W∈[0,1]^{KL×KL} may be created where each diagonal element is the corresponding weight of each sample μ(sₖ)α(σₖₗ), where μ(sₖ) is the weight of sample subset sₖ and α(σₖₗ) is the weight of permutation σₖₗ.

In some examples, each weight may be uniform (e.g., equal weights to all sample subsets and/or permutations). By way of example, the coefficient α(σ) may be uniform in the general formulation. In addition, or alternatively, each weigh may be used to prioritize feature subsets 408 and/or time permuted feature subsets 410 based on one or more weighting criteria. The weighting criteria, for example, may include a likelihood probability in which a weight is generated based on a likelihood of a feature subset 408 and/or time permuted feature subset 410 in a real-world scenario. In this manner, the coefficient α(σ) may be used to enforce a priori constraints that restrict the set of permutations (e.g., only sample realistic permutations). By way of example, coefficient α(σ) may be proportional to the likelihood of a given time permuted feature subset 410.

In some embodiments, the classification machine learning model is a data structure that describes parameters, hyper-parameters, and/or defined operations of a rules-based and/or machine learning model (e.g., model including at least one of one or more rule-based layers, one or more layers that depend on trained parameters, coefficients, and/or the like). The classification machine learning model may include any type of model configured, trained, and/or the like to process a time permuted feature subset 410 and, in response to the time permuted feature subset 410, output a likelihood prediction for the time permuted feature subset 410. In some examples, the classification machine learning model may include a neural network architecture that is trained, using backpropagation of errors, to optimize a likelihood loss (e.g., using a maximum likelihood estimation, etc.). The classification machine learning model, for example, may be trained using a distribution of a plurality of historical temporally ordered input feature sequences.

In some embodiments, an evaluation output 416 is generated based on the time permuted feature subset. For example, the evaluation output 416 may be generated using the target machine learning model 404. For example, the time permuted feature subset 410 may be input to the target machine learning model 404 to receive the evaluation output 416. In some examples, an evaluation output vector 418 may be generated by arranging the evaluation output 416 with a plurality of different evaluation outputs respectively corresponding to a plurality of different time permuted feature subsets sampled from the temporally ordered input feature sequence 402.

In some embodiments, the evaluation output 416 is an unexplainable output received from the target machine learning model 404 in response to the time permuted feature subset 410. An evaluation output, for example, may be generated by inputting a time permuted feature subset 410 to the target machine learning model 404. In some examples, the evaluation output 416 may be generated for each of a plurality of time permuted feature subsets 410. For example, for each of the KL time permuted feature subsets 410, a time permuted feature subset 410 may be input to the target machine learning model 404 to generate the evaluation output 416 (e.g., predicted probability for a classification, etc.). In some examples, the evaluation outputs 416 may be stored to generate an evaluation output vector 418, F∈ [symbol] . The evaluation output vector 418, for example, may include an evaluation output 416 for each time permuted feature subset 410 of a permutation matrix.

In some embodiments, a time impact prediction 424 is identified for a target feature from the plurality of features based on the evaluation output 416 and the model output 406. For example, the evaluation output vector 418, the model output 406, and a feature matrix (e.g., the transformed permutation matrix 414 and/or the weighted transformed permutation matrix 420) may be input to an explainability model 422 to generate a plurality of time impact predictions 424 for the features of the temporally ordered input feature sequence 402. Each time impact prediction 424 may identify an impact of varying a time position of a target feature within the temporally ordered input feature sequence 402.

In some examples, the time impact predictions 424 may be generated based on a plurality of Shapley coefficients of the explainability model 422. For example, the explainability model 422 may include a regression model and a plurality of Shapley coefficients for the plurality of features of a temporally ordered input feature sequence 402 may be generated, using weighted least squares regression, based on the permutation matrix, the evaluation output vector 418, and the model output 406. In addition, or alternatively, the plurality of Shapley coefficients may be generated, using weighted least squares regression, based on the transformed permutation matrix 414, the evaluation output vector 418, and the model output 406. In some examples, the plurality of Shapley coefficients may be generated, using weighted least squares regression, based on the weighted transformed permutation matrix 420, the evaluation output vector 418, and the model output 406.

In some embodiments, the time impact prediction 424 is a data value that describes a relative measure of the impact of a time variance for a time-based feature to an output by a machine learning model. A time impact prediction 424, for example, may include an explainability value specifically designed to explain a temporal significance of a feature within a temporally ordered input feature sequence 402. In some examples, a time impact prediction 424 may include an aggregation of a plurality of augmented Shapley values, Ord-SHAP, that may be generated, using weighted least-squares regression. In addition, or alternatively, Shapley sampling values, and/or the like, may be leveraged to generate the time impact prediction 424.

In some embodiments, a time impact prediction 424 is based on a Shapley coefficient φ, solved using the following equation:

$$φ = {( {Σ}^{T} W Σ )}^{- 1} {Σ}^{T} W F$$

The Shapley coefficient, φ, may measure an effect (e.g., weight) of varying the position of each feature in the temporally ordered input feature sequence 402 on a model output 406, given the specific ordering of the temporally ordered input feature sequence 402. In this manner, a time impact prediction 424 may provide a local attribution measure (e.g., specific to a particular temporally ordered input feature sequence 402) as opposed to traditional explainability techniques that are limited to global attribution measures (e.g., the effect across a plurality of temporally ordered input feature sequences 402 in a distribution).

In some examples, a magnitude of a plurality of Shapley coefficients (e.g., regression weights) may be compared to determine the time impact prediction 424 for a target feature. For instance, the time impact prediction 424 may be output for each time-based feature that reflects the feature's temporal significance. The time impact prediction 424 may be an aggregation of the Shapley coefficients (e.g., resulting coefficients are the Ord-SHAP values) for a particular time-based feature (e.g., target feature).

In some embodiments, the target feature is a feature of the temporally ordered input feature sequence 402 that is associated with explainable metadata. A target feature, for example, may include a time-based feature that is associated with the time impact prediction 424.

The time impact prediction 424 of a target feature may be identified from the plurality of Shapley coefficients. In some examples, a plurality of time impact predictions 424 is identified for the plurality of features of the temporally ordered input feature sequence 402. A target feature may be assigned to a quantile bin based on the plurality of time impact predictions 424.

In some embodiments, the quantile bin is a data structure that describes a feature associated with a range of time impact values. A quantile bin, for example, may be based on a distribution of time impact values and/or Shapley coefficients for a temporally ordered input feature sequence 402. For example, a quantile bin may include an evenly divided portion of the Shapley coefficients (and/or time impact values) that is determined by dividing the Shapley coefficients into bins based on a bin size (e.g., quartiles (four bins), quintiles (five bins), deciles (ten bins), etc.). In some examples, a plurality of time impact values (e.g., one for each time-based feature of a temporally ordered input feature sequence 402, etc.) may be binned by quantiles, based on a distribution of the Shapley coeffects, and/or the like, to determine a relative significance between each of the time-based features of the temporally ordered input feature sequence 402.

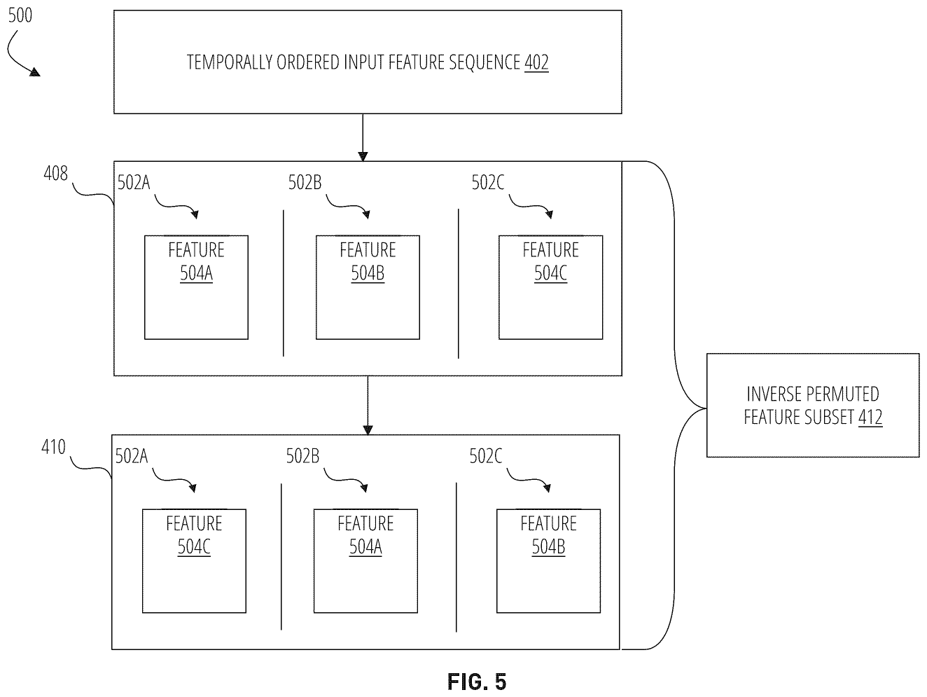

In some embodiments, a time-based feature importance representation 426 is provided that reflects the target feature relative to the plurality of features based on the one or more quantile bins. The time-based feature importance representation 426, for example, may be provided via a user interface. In this manner, the explainability pipeline of the present disclosure may leverage a new sequence of feature data structures to provide local feature attribution measures for various features of an input to the target machine learning model 404 that evaluates the importance of both the timing and the presence of feature relative to other features of the input. These data structures are described in further detail with reference to FIG. 5.

FIG. 5 is an operational example 500 showing example feature data structures leveraged by a time-based explainability framework in accordance with some embodiments discussed herein. The operational example 500 illustrates a plurality of feature data structures that may be derived (e.g., sampled, extracted, drawn, etc.) from a temporally ordered input feature sequence 402. The plurality of feature data structures may include a feature subset 408, a time permuted feature subset 410, and/or an inverse permuted feature subset 412. As described herein, each of the feature data structures may be arranged within a respective feature matrix to account for a plurality of variations of the respective feature data structures.

The feature subset 408 may include a plurality of features 504A-C from the temporally ordered input feature sequence 402 that are ordered in accordance with the temporal ordering defined by the temporally ordered input feature sequence 402. For instance, a first feature 504A may include a first time position 502A, a second feature 504B may include a second time position 502B, a third feature 504N may include a third time position 502C, and/or the like.

The time permuted feature subset 410 may include the plurality of features 504A-C ordered in accordance with a permuted ordering different than the temporal ordering defined by the temporally ordered input feature sequence 402. For example, the first feature 504A may be moved to the second time position 502B, the second feature 504B may be moved to the third time position 502C, the third feature 504C may be moved to the first time position 502A, and/or the like.

The inverse permuted feature subset may describe a distance between the respective time positions of the features 504A-C in each of the feature subset 408 and time permuted feature subset 410. By way of example, the inverse permuted feature subset 412 may include a vector with the values of −3, +1, +1, and/or the like.

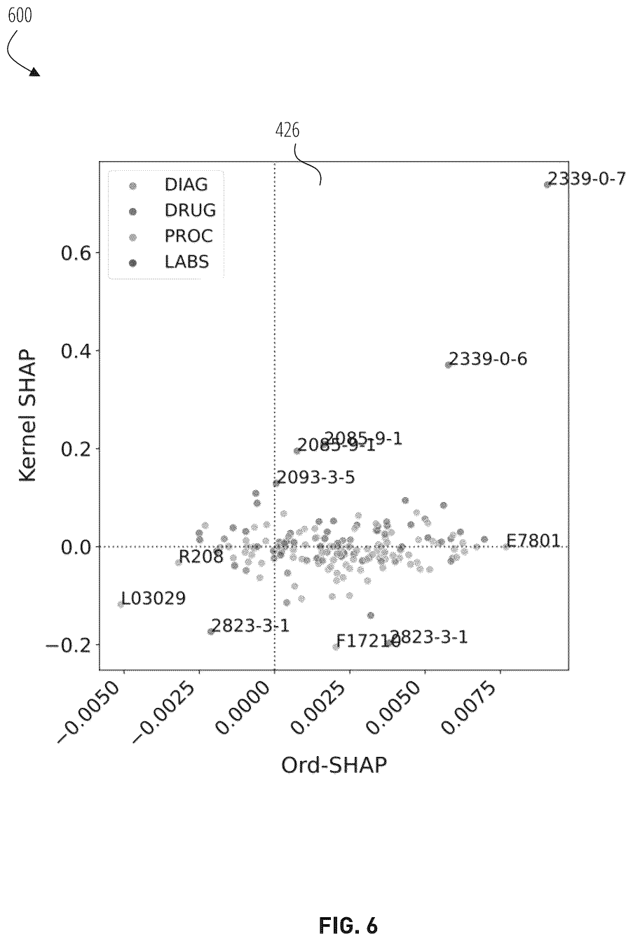

As described herein, these feature data structures may be leveraged, using the techniques of the present disclosure, to generate a time-based feature importance representation descriptive of the importance of both the time positions 502A-C and the presence of the features 504A-C to a model's output. The time-based feature importance representation is described in further detail with reference to FIG. 6.

FIG. 6 is an operational example 600 showing an example time-based feature importance representation in accordance with some embodiments discussed herein. In some embodiments, the time-based feature importance representation 426 is a graphical representation that describes a relative importance of a timing expressed by a temporally ordered input feature sequence. A time-based feature importance representation may include a model explainability user interface configured to describe a relative importance of the specific ordering in a temporally ordered input feature sequence to a model output. In some examples, the time-based feature importance representation may include a plurality of time-based features extracted from a temporally ordered input feature sequence and plotted along an importance axis to visually illustrate the relative importance of each of the time-based features of the temporally ordered input feature sequence.

In some examples, a time-based feature importance representation may include a plurality of different explainability measures for each of a plurality of time-based features. The plurality of different explainability measures, for example, may include traditional feature importance measures, such as Kernel SHAP values, and/or the like, that measure an importance of a presence and/or absence of a feature in a feature sequence. By way of example, a time-based feature importance representation may include a multi-dimensional representation in which each feature of a temporally ordered input feature sequence is positioned based on a plurality of explainability measures. For instance, a feature may be positioned along a first dimension based on a presence measure (Kernel SHAP, etc.) of an importance of the presence of the feature to a model output. In addition, or alternatively, a feature may be positioned along a second dimension based on a timing measure (e.g., time impact prediction, etc.) of an importance of the timing of the feature to a model output.

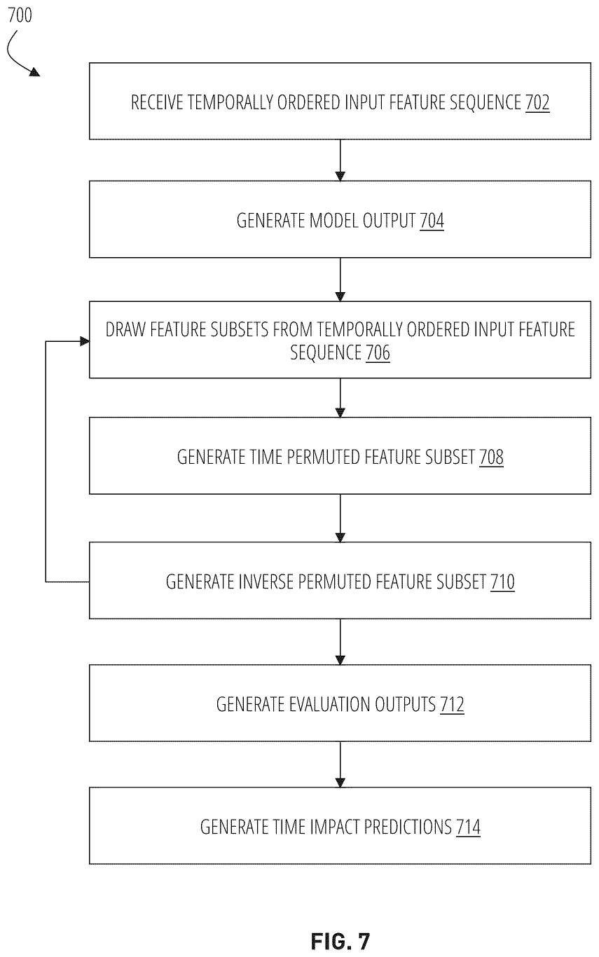

FIG. 7 is a flowchart diagram of an example process 700 for implementing a time-based explainability framework in accordance with some embodiments discussed herein. The flowchart depicts a model explainability process 700 for generating improved explainability measures that account for both the timing and the presence of a feature within a model input. The process 700 may be implemented by one or more computing devices, entities, and/or systems described herein. For example, via the various steps/operations of the process 700, the computing system 101 may leverage an improved explainability pipeline to generate time impact predictions that are specially tailored to address technical challenges observed in machine learning technology. By doing so, the process 700 facilitates explainability techniques that are directly tailored to temporal sequence models to address challenges, such as a lack of model interpretability, unique to such technology.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, receiving temporally ordered input feature sequence. For example, the computing system 101 may receive the temporally ordered input feature sequence as an input for a target machine learning model. The temporally ordered input feature sequence may include a plurality of features respectively assigned to a plurality of time positions within the temporally ordered input feature sequence.

In some examples, the temporally ordered input feature sequence may correspond to a data entity that is associated with a plurality of historical data objects respectively corresponding to one or more historical time points. The temporally ordered input feature sequence may be generated by identifying one or more features from each of the plurality of historical data objects and concatenating the one or more features from each of the plurality of historical data objects in accordance with the plurality of time positions based on the one or more historical time points.

In some embodiments, the process 700 includes, at step/operation 704, generating model output. For example, the computing system 101 may generate, using the target machine learning model, a model output based on the temporally ordered input feature sequence. For instance, the computing system 101 may input the temporally ordered input feature sequence to the target machine learning model to receive the model output.

In some embodiments, the process 700 includes, at step/operation 706, drawing feature subsets from temporally ordered input feature sequence. For example, the computing system 101 may generate a feature subset from the temporally ordered input feature sequence. The feature subset may include a subset of features from the plurality of features that are arranged according to a subset of the plurality of time positions that respectively correspond to the subset of features.

In some embodiments, the process 700 includes, at step/operation 708, generating time permuted feature subset. For example, the computing system 101 may generate a time permuted feature subset from the feature subset by assigning one or more of the subset of features to one or more different time positions of the subset of the plurality of time positions. In some examples, the computing system 101 may generate a permutation matrix by arranging the time permuted feature subset with a plurality of different time permuted feature subsets.

In some embodiments, the process 700 includes, at step/operation 710, generating inverse permuted feature subset. For example, the computing system 101 may generate a transformed permutation matrix by generating an inverse permuted feature subset for the time permuted feature subset and each of the plurality of different time permuted feature subsets. The inverse permuted feature subset may identify a distance between (i) an initial time position of a feature within a feature subset and (ii) a permuted time position of the feature within the time permuted feature subset.

In some examples, the computing system 101 may generate a weighted transformed permutation matrix by applying a diagonal weighting matrix to the transformed permutation matrix. The diagonal weighting matrix may define a weight for the time permuted feature subset based on a predicted likelihood of the time permuted feature subset. In some examples, the predicted likelihood of the time permuted feature subset may be generated using a classification machine learning model previously trained on a plurality of labelled feature subsets.

In some embodiments, the process 700 includes, at step/operation 712, generating evaluation output. For example, the computing system 101 may generate, using the target machine learning model, an evaluation output based on the time permuted feature subset. For instance, the computing system 101 may input the time permuted feature subset to the target machine learning model to receive the evaluation output. In some examples, the computing system 101 may generate an evaluation output vector by arranging the evaluation output with a plurality of different evaluation outputs respectively corresponding to the plurality of different time permuted feature subsets.

In some embodiments, the process 700 includes, at step/operation 714, generate time impact predictions. For example, the computing system 101 may identify a time impact prediction of a target feature from the plurality of features based on the evaluation output and the model output. The time impact prediction of the target feature may identify an impact of varying a time position of the target feature within the temporally ordered input feature sequence.

In some examples, the computing system 101 may generate, using weighted least squares regression, a plurality of Shapley coefficients for the plurality of features based on the permutation matrix, the evaluation output vector, and the model output. In addition, or alternatively, the computing system 101 may generate, using weighted least squares regression, the plurality of Shapley coefficients for the plurality of features based on the transformed permutation matrix, the evaluation output vector, and the model output. In addition, or alternatively, the computing system 101 may generate, using weighted least squares regression, the plurality of Shapley coefficients for the plurality of features based on the weighted transformed permutation matrix, the evaluation output vector, and the model output. The computing system 101 may identify the time impact prediction of the target feature from the plurality of Shapley coefficients.

In some examples, the computing system 101 may identify a plurality of time impact predictions for the plurality of feature values. The computing system 101 may assign the target feature and the plurality of features to one or more quantile bins based on the plurality of time impact predictions. In some examples, the computing system 101 may provide, via a user interface, a time-based feature importance representation that reflects the target feature relative to a plurality of features based on the one or more quantile bins.

Some techniques of the present disclosure enable the generation of actionable outputs that may be performed to initiate one or more real world actions to achieve real-world effects. The explainability techniques of the present disclosure may be used, applied, and/or otherwise leveraged to evaluate machine learning model outputs. The comprehension of machine learning model outputs may trigger the performance of various computing tasks that improve the performance of a computing system (e.g., a computer itself, etc.) with respect to various actions performed by the computing system. Example actions may include the machine learning training operations (e.g., by incorporating explainability-based compliance mechanisms into a training pipeline, etc.) as well as the display, transmission, notification, and/or the like of data reflective of a machine learning model's performance, such as the time impact predictions as described herein. Moreover, the actions may include physical actions, such as the provision of a control instruction to reboot a computer, control a robotic device to perform a debugging routine, and/or the like, that may be triggered in response to a time impact prediction.

In some examples, the computing tasks may include actions that may be based on a prediction domain. A prediction domain may include any environment in which computing systems may be applied to generate predictive insights and initiate the performance of computing tasks responsive to the predictive insights. These actions may cause real-world changes, for example, by controlling a hardware component, providing alerts, interactive actions, and/or the like. For instance, actions may include the initiation of automated instructions across and between devices, automated notifications, automated maintenance operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising generating, by one or more processors and using a target machine learning model, a model output based on a temporally ordered input feature sequence that comprises a plurality of features respectively assigned to a plurality of time positions within the temporally ordered input feature sequence; generating, by the one or more processors, a feature subset from the temporally ordered input feature sequence that comprises a subset of features from the plurality of features that are arranged according to a subset of the plurality of time positions that respectively correspond to the subset of features; generating, by the one or more processors, a time permuted feature subset from the feature subset by assigning one or more of the subset of features to one or more different time positions of the subset of the plurality of time positions; generating, by the one or more processors and using the target machine learning model, an evaluation output based on the time permuted feature subset; and identifying, by the one or more processors, a time impact prediction of a target feature from the plurality of features based on the evaluation output and the model output.

Example 2. The computer-implemented method of claim 1, wherein generating the model output comprises inputting the temporally ordered input feature sequence to the target machine learning model to receive the model output and generating the evaluation output comprises inputting the time permuted feature subset to the target machine learning model to receive the evaluation output.

Example 3. The computer-implemented method of any of the preceding claims, wherein the temporally ordered input feature sequence corresponds to a data entity that is associated with a plurality of historical data objects respectively corresponding to one or more historical time points and the temporally ordered input feature sequence is generated by identifying one or more features from each of the plurality of historical data objects, and concatenating the one or more features from each of the plurality of historical data objects in accordance with the plurality of time positions based on the one or more historical time points.

Example 4. The computer-implemented method of any of the preceding claims, wherein the time impact prediction of the target feature identifies an impact of varying a time position of the target feature within the temporally ordered input feature sequence.

Example 5. The computer-implemented method of any of the preceding claims, wherein identifying the time impact prediction of the target feature comprises generating a permutation matrix by arranging the time permuted feature subset with a plurality of different time permuted feature subsets; generating an evaluation output vector by arranging the evaluation output with a plurality of different evaluation outputs respectively corresponding to the plurality of different time permuted feature subsets; generating, using weighted least squares regression, a plurality of Shapley coefficients for the plurality of features based on the permutation matrix, the evaluation output vector, and the model output; and identifying the time impact prediction of the target feature from the plurality of Shapley coefficients.

Example 6. The computer-implemented method of claim 5, further comprising generating a transformed permutation matrix by generating an inverse permuted feature subset for the time permuted feature subset and each of the plurality of different time permuted feature subsets; and generating, using weighted least squares regression, the plurality of Shapley coefficients for the plurality of features based on the transformed permutation matrix, the evaluation output vector, and the model output.

Example 7. The computer-implemented method of claim 6, wherein the inverse permuted feature subset identifies a distance between (i) an initial time position of a feature within the feature subset and (ii) a permuted time position of the feature within the time permuted feature subset.

Example 8. The computer-implemented method of any of claims 6 of 7, further comprising generating a weighted transformed permutation matrix by applying a diagonal weighting matrix to the transformed permutation matrix, wherein the diagonal weighting matrix defines a weight for the time permuted feature subset based on a predicted likelihood of the time permuted feature subset; and generating, using weighted least squares regression, the plurality of Shapley coefficients for the plurality of features based on the weighted transformed permutation matrix, the evaluation output vector, and the model output.

Example 9. The computer-implemented method of claim 8, wherein the predicted likelihood of the time permuted feature subset is generated using a classification machine learning model previously trained on a plurality of labelled feature subsets.

Example 10. The computer-implemented method any of the preceding claims, further comprising identifying a plurality of time impact predictions for the plurality of features; assigning the target feature and the plurality of features to one or more quantile bins based on the plurality of time impact predictions; and providing, via a user interface, a time-based feature importance representation that reflects the target feature relative to the plurality of features based on the one or more quantile bins.

Example 11. A system comprising memory and one or more processors communicatively coupled to the memory, the one or more processors configured to generate, using a target machine learning model, a model output based on a temporally ordered input feature sequence that comprises a plurality of features respectively assigned to a plurality of time positions within the temporally ordered input feature sequence; generate a feature subset from the temporally ordered input feature sequence that comprises a subset of features from the plurality of features that are arranged according to a subset of the plurality of time positions that respectively correspond to the subset of features; generate a time permuted feature subset from the feature subset by assigning one or more of the subset of features to one or more different time positions of the subset of the plurality of time positions; generating, using the target machine learning model, an evaluation output based on the time permuted feature subset; and identify a time impact prediction of a target feature from the plurality of features based on the evaluation output and the model output.

Example 12. The system of claim 11, wherein generating the model output comprises inputting the temporally ordered input feature sequence to the target machine learning model to receive the model output and generating the evaluation output comprises inputting the time permuted feature subset to the target machine learning model to receive the evaluation output.

Example 13. The system of any of claims 11 to 12, wherein the temporally ordered input feature sequence corresponds to a data entity that is associated with a plurality of historical data objects respectively corresponding to one or more historical time points and the temporally ordered input feature sequence is generated by identifying one or more features from each of the plurality of historical data objects, and concatenating the one or more features from each of the plurality of historical data objects in accordance with the plurality of time positions based on the one or more historical time points.

Example 14. The system of any of claims 11 to 13, wherein the time impact prediction of the target feature identifies an impact of varying a time position of the target feature within the temporally ordered input feature sequence.

Example 15. The system any of claims 11 to 14, wherein identifying the time impact prediction of the target feature comprises generating a permutation matrix by arranging the time permuted feature subset with a plurality of different time permuted feature subsets; generating an evaluation output vector by arranging the evaluation output with a plurality of different evaluation outputs respectively corresponding to the plurality of different time permuted feature subsets; generating, using weighted least squares regression, a plurality of Shapley coefficients for the plurality of features based on the permutation matrix, the evaluation output vector, and the model output; and identifying the time impact prediction of the target feature from the plurality of Shapley coefficients.

Example 16. The system of claim 15, wherein the one or more processors are further configured to generate a transformed permutation matrix by generating an inverse permuted feature subset for the time permuted feature subset and each of the plurality of different time permuted feature subsets; and generate, using weighted least squares regression, the plurality of Shapley coefficients for the plurality of features based on the transformed permutation matrix, the evaluation output vector, and the model output.

Example 17. The system of claim 16, wherein the inverse permuted feature subset identifies a distance between (i) an initial time position of a feature within the feature subset and (ii) a permuted time position of the feature within the time permuted feature subset.

Example 18. The system of claim 16, wherein the one or more processors are further configured to generate a weighted transformed permutation matrix by applying a diagonal weighting matrix to the transformed permutation matrix, wherein the diagonal weighting matrix defines a weight for the time permuted feature subset based on a predicted likelihood of the time permuted feature subset; and generate, using weighted least squares regression, the plurality of Shapley coefficients for the plurality of features based on the weighted transformed permutation matrix, the evaluation output vector, and the model output.

Example 19. The system of claim 18, wherein the predicted likelihood of the time permuted feature subset is generated using a classification machine learning model previously trained on a plurality of labelled feature subsets.

Example 20. One or more non-transitory computer-readable storage media including instructions that, when executed by one or more processors, cause the one or more processors to generate, using a target machine learning model, a model output based on a temporally ordered input feature sequence that comprises a plurality of features respectively assigned to a plurality of time positions within the temporally ordered input feature sequence; generate a feature subset from the temporally ordered input feature sequence that comprises a subset of features from the plurality of features that are arranged according to a subset of the plurality of time positions that respectively correspond to the subset of features; generate a time permuted feature subset from the feature subset by assigning one or more of the subset of features to one or more different time positions of the subset of the plurality of time positions; generating, using the target machine learning model, an evaluation output based on the time permuted feature subset; and identify a time impact prediction of a target feature from the plurality of features based on the evaluation output and the model output.

Example 21. The computer-implemented method of example 1, wherein the method further comprises training the target machine learning model based on the time impact prediction.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The system of example 11, wherein the one or more processors are further configured to train the target machine learning model based on the time impact prediction.

Example 25. The system of example 11, wherein the one or more processors are included in a first computing entity; and the target machine learning model is trained by one or more other processors included in a second computing entity.

Example 26. The one or more non-transitory computer-readable storage media of example 18, wherein the instructions further cause the one or more processors to train the target machine learning model based on the time impact prediction.

Example 27. The one or more non-transitory computer-readable storage media of example 18, wherein the one or more processors are included in a first computing entity; and the target machine learning model is trained by one or more other processors included in a second computing entity.

1. A computer-implemented method comprising:
generating, by one or more processors and using a target machine learning model, a model output based on a temporally ordered input feature sequence that comprises a plurality of features respectively assigned to a plurality of time positions within the temporally ordered input feature sequence;
generating, by the one or more processors, a feature subset from the temporally ordered input feature sequence that comprises a subset of features from the plurality of features that are arranged according to a subset of the plurality of time positions that respectively correspond to the subset of features;
generating, by the one or more processors, a time permuted feature subset from the feature subset by assigning one or more of the subset of features to one or more different time positions of the subset of the plurality of time positions;
generating, by the one or more processors and using the target machine learning model, an evaluation output based on the time permuted feature subset; and
identifying, by the one or more processors, a time impact prediction of a target feature from the plurality of features based on the evaluation output and the model output.

2. The computer-implemented method of claim 1, wherein generating the model output comprises inputting the temporally ordered input feature sequence to the target machine learning model to receive the model output and generating the evaluation output comprises inputting the time permuted feature subset to the target machine learning model to receive the evaluation output.

3. The computer-implemented method of claim 1, wherein the temporally ordered input feature sequence corresponds to a data entity that is associated with a plurality of historical data objects respectively corresponding to one or more historical time points and the temporally ordered input feature sequence is generated by:
identifying one or more features from each of the plurality of historical data objects, and
concatenating the one or more features from each of the plurality of historical data objects in accordance with the plurality of time positions based on the one or more historical time points.

4. The computer-implemented method of claim 1, wherein the time impact prediction of the target feature identifies an impact of varying a time position of the target feature within the temporally ordered input feature sequence.

5. The computer-implemented method of claim 1, wherein identifying the time impact prediction of the target feature comprises:
generating a permutation matrix by arranging the time permuted feature subset with a plurality of different time permuted feature subsets;
generating an evaluation output vector by arranging the evaluation output with a plurality of different evaluation outputs respectively corresponding to the plurality of different time permuted feature subsets;
generating, using weighted least squares regression, a plurality of Shapley coefficients for the plurality of features based on the permutation matrix, the evaluation output vector, and the model output; and
identifying the time impact prediction of the target feature from the plurality of Shapley coefficients.

6. The computer-implemented method of claim 5, further comprising:
generating a transformed permutation matrix by generating an inverse permuted feature subset for the time permuted feature subset and each of the plurality of different time permuted feature subsets; and
generating, using weighted least squares regression, the plurality of Shapley coefficients for the plurality of features based on the transformed permutation matrix, the evaluation output vector, and the model output.

7. The computer-implemented method of claim 6, wherein the inverse permuted feature subset identifies a distance between (i) an initial time position of a feature within the feature subset and (ii) a permuted time position of the feature within the time permuted feature subset.

8. The computer-implemented method of claim 6, further comprising:
generating a weighted transformed permutation matrix by applying a diagonal weighting matrix to the transformed permutation matrix, wherein the diagonal weighting matrix defines a weight for the time permuted feature subset based on a predicted likelihood of the time permuted feature subset; and
generating, using weighted least squares regression, the plurality of Shapley coefficients for the plurality of features based on the weighted transformed permutation matrix, the evaluation output vector, and the model output.

9. The computer-implemented method of claim 8, wherein the predicted likelihood of the time permuted feature subset is generated using a classification machine learning model previously trained on a plurality of labelled feature subsets.

10. The computer-implemented method of claim 1, further comprising:
identifying a plurality of time impact predictions for the plurality of features;
assigning the target feature and the plurality of features to one or more quantile bins based on the plurality of time impact predictions; and
providing, via a user interface, a time-based feature importance representation that reflects the target feature relative to the plurality of features based on the one or more quantile bins.

11. A system comprising memory and one or more processors communicatively coupled to the memory, the one or more processors configured to:
generate, using a target machine learning model, a model output based on a temporally ordered input feature sequence that comprises a plurality of features respectively assigned to a plurality of time positions within the temporally ordered input feature sequence;
generate a feature subset from the temporally ordered input feature sequence that comprises a subset of features from the plurality of features that are arranged according to a subset of the plurality of time positions that respectively correspond to the subset of features;
generate a time permuted feature subset from the feature subset by assigning one or more of the subset of features to one or more different time positions of the subset of the plurality of time positions;
generating, using the target machine learning model, an evaluation output based on the time permuted feature subset; and
identify a time impact prediction of a target feature from the plurality of features based on the evaluation output and the model output.

12. The system of claim 11, wherein:
to generate the model output, the one or more processors are further configured to input the temporally ordered input feature sequence to the target machine learning model to receive the model output, and
to generate the evaluation output, the one or more processors are further configured to input the time permuted feature subset to the target machine learning model to receive the evaluation output.

13. The system of claim 11, wherein the temporally ordered input feature sequence corresponds to a data entity that is associated with a plurality of historical data objects respectively corresponding to one or more historical time points and to generate the temporally ordered input feature sequence, the one or more processors are further configured to:
identify one or more features from each of the plurality of historical data objects, and
concatenate the one or more features from each of the plurality of historical data objects in accordance with the plurality of time positions based on the one or more historical time points.

14. The system of claim 11, wherein the time impact prediction of the target feature identifies an impact of varying a time position of the target feature within the temporally ordered input feature sequence.

15. The system of claim 11, wherein to identify the time impact prediction of the target feature, the one or more processors are further configured to:
generate a permutation matrix by arranging the time permuted feature subset with a plurality of different time permuted feature subsets;
generate an evaluation output vector by arranging the evaluation output with a plurality of different evaluation outputs respectively corresponding to the plurality of different time permuted feature subsets;
generate, using weighted least squares regression, a plurality of Shapley coefficients for the plurality of features based on the permutation matrix, the evaluation output vector, and the model output; and
identify the time impact prediction of the target feature from the plurality of Shapley coefficients.

16. The system of claim 15, wherein the one or more processors are further configured to:
generate a transformed permutation matrix by generating an inverse permuted feature subset for the time permuted feature subset and each of the plurality of different time permuted feature subsets; and
generate, using weighted least squares regression, the plurality of Shapley coefficients for the plurality of features based on the transformed permutation matrix, the evaluation output vector, and the model output.

17. The system of claim 16, wherein the inverse permuted feature subset identifies a distance between (i) an initial time position of a feature within the feature subset and (ii) a permuted time position of the feature within the time permuted feature subset.

18. The system of claim 16, wherein the one or more processors are further configured to:
generate a weighted transformed permutation matrix by applying a diagonal weighting matrix to the transformed permutation matrix, wherein the diagonal weighting matrix defines a weight for the time permuted feature subset based on a predicted likelihood of the time permuted feature subset; and
generate, using weighted least squares regression, the plurality of Shapley coefficients for the plurality of features based on the weighted transformed permutation matrix, the evaluation output vector, and the model output.

19. The system of claim 18, wherein the predicted likelihood of the time permuted feature subset is generated using a classification machine learning model previously trained on a plurality of labelled feature subsets.

20. One or more non-transitory computer-readable storage media including instructions that, when executed by one or more processors, cause the one or more processors to:
generate, using a target machine learning model, a model output based on a temporally ordered input feature sequence that comprises a plurality of features respectively assigned to a plurality of time positions within the temporally ordered input feature sequence;
generate a feature subset from the temporally ordered input feature sequence that comprises a subset of features from the plurality of features that are arranged according to a subset of the plurality of time positions that respectively correspond to the subset of features;
generate a time permuted feature subset from the feature subset by assigning one or more of the subset of features to one or more different time positions of the subset of the plurality of time positions;
generating, using the target machine learning model, an evaluation output based on the time permuted feature subset; and
identify a time impact prediction of a target feature from the plurality of features based on the evaluation output and the model output.
